(19) United States
(12) Patent Application Publication
(10) Pub. No.: US 2006/0121994 A1
(43) Pub. Date: Jun. 8, 2006

(54) Stir welded drive shaft and method of making same

(76) Inventors: David Mark Douglass, Plymouth, MI (US); Robert Earl Dines, Waterford, MI (US)

Correspondence Address: AUTOMOTIVE COMPONENTS HOLDINGS, LLC;c/o MACMILLAN SOBANSKI & TODD, One Maritime Plaza, Fourth Floor, 720 Water Street, Toledo, OH, 43604-1853, US

(21) Appl. No.: 11/004,417

(22) Filed: Dec. 3, 2004

(51) Int. Cl. F16D 3/16

(52) U.S. Cl. 464/127

(57) ABSTRACT

A stir-welded drive shaft and a method of forming a stir-welded drive shaft. The stir-welded drive shaft is formed by the process of providing a yoke and a tube, and stir welding said yoke to said tube to define the driveshaft. A balance weight may be added to the tube after stir welding said yoke to said tube. The yoke may also include a pilot having a contact surface and an outer shoulder, wherein the contact surface and outer shoulder engage the tube to form a joint interface. The driveshaft is generally stir welded at along the joint interface.

### BACKGROUND OF THE INVENTION

The present invention relates to a stir-welded drive shaft and a method of forming a stir-welded drive shaft.

Several welding processes are known and widely used in various industries, including the automotive industry. Various automobile parts, including drive shafts, are made by welding processes. Welding processes currently used for drive shafts include gas-metal-arc welding, laser welding, friction welding, and magnetically impelled arc butt welding.

Drive shafts are typically formed from a pair of yokes welded to each end of a long cylindrical tube. Traditionally iron or steel is used to form drive shafts, but recently aluminum is replacing steel as the preferred material. Aluminum drive shafts are significantly lighter than steel drive shafts, helping vehicle manufacturers reduce the weight of vehicles for improved performance and gas mileage.

Current methods of manufacturing drive shafts have various associated problems which may cause increased manufacturing costs due to a high scrap rate of defective parts or additional processes needed to aid in balancing the shafts. For example, driveshafts welded by gas-metal-arc welding experience a significant amount of heat during the welding process. Heat absorbed during the welding of the yokes to the tube, as well as welding of the balance weights to the tube, may cause distortion of the drive shaft, especially of the hollow tube. Distortion of the drive shaft, especially the tube, can result in run out, imbalance of the tube, and misalignment of the yokes. Each of these problems may cause unacceptable levels of noise, vibration and harshness concerns. Material added from the welding process as well as splatter occurring during the welding process may also cause imbalance issues or limit the balance corrections made as balance weights are added.

The above problems are compounded with the manufacture of aluminum drive shafts. Aluminum drive shafts are generally more susceptible to heat distortion than steel drive shafts. It is also generally harder to straighten or balance an aluminum drive shaft than a steel drive shaft. Another problem with aluminum drive shafts is that any balance weights added through the heat intensive process of gas-metal-arc welding may cause further distortion and imbalance to the aluminum tube. Yet another problem with gas-metal-arc welding is that typically each time the balance of the drive shaft is checked, it must be put on a separate machine, thereby increasing manufacturing and assembly time and cost. Given the ever increasing demands for reduced heat distortion, shortened weld times per cycle, and reduced manufacturing and assembly costs, manufacturers are continually researching new ways to improve the efficiency of assembly, welding, and balancing of drive shafts.

Some manufacturers have turned to other welding processes to overcome some of the above problems associated with gas-metal-arc welding. One such method is friction welding. In friction welding, at least one of the yoke and tube is spun at a high speed relative to the other while they are pressed into engaging contact. The friction created between the tube and yoke generates a sufficient amount of heat to weld the yoke and tube together. While heat distortion is reduced, some distortion still occurs due to the frictional heat generated and the large forging loads applied. One difficulty in friction welding is aligning the parts and maintaining that alignment while the at least one part is rotated at a high speed relative to the other and the parts are pressed together. Therefore, unbalanced drive shafts may easily occur due to misalignment. Misalignment problems are difficult to correct with balance weights, and aluminum drive shafts are difficult to straighten. Therefore, while friction welding reduces heat distortion, other problems occur that minimize any efficiencies gained due to reduced heat distortion. Further, other welding processes must generally be used when adding balance weights to correct imbalance issues, further raising manufacturing costs.

Other manufacturers have recently turned to laser welding for reduced heat distortion and to avoid many of the other problems that occur in friction welding and gas-metal-arc welding. While laser welding reduces heat distortion, some heat distortion still occurs. Laser welding, although causing less heat distortion than gas-metal-arc welding, causes enough heat distortion to distort the drive shaft, especially the tube. This distortion also requires balancing of the drive shaft after the welding process.

Balancing of a drive shaft typically requires the installation of balance weights on the tube or removal of material from portions of the yoke. Each of these processes in balancing a drive shaft is time consuming as each drive shaft needs to be separately balanced. As discussed above, the welding of balancing weights, especially gas-metal-arc welding the balance weights to the hollow tube, easily causes distortion of the tube, making it difficult to correct imbalance issues without creating new imbalance issues. Due to the face welding of balance weights to the tube, even laser welding causes the tube to experience a significant amount of heat. Excessive heat applied to the tube may weaken the tube in addition to causing distortion, misalignment, and imbalance. Therefore, manufacturers have been searching for low heat processes to minimize heat distortion, eliminate welding splatter, eliminate alignment issues, and minimize imbalance issues during the manufacturing process.

### SUMMARY OF THE INVENTION

The present invention relates to a stir-welded drive shaft and a method of forming a stir-welded drive shaft. The stir-welded drive shaft is formed by the process of providing a yoke and a tube, and stir welding said yoke to said tube to define the driveshaft. A balance weight may be added to the tube after stir welding said yoke to said tube. The yoke may also include a pilot having a contact surface and an outer shoulder, wherein the contact surface and outer shoulder engage the tube to form a joint interface. The driveshaft is generally stir welded at some point along the joint interface.

The method of forming the driveshaft generally includes the steps of coupling a yoke and a tube to a stir welding apparatus, engaging the yoke against the tube, and stir welding the yoke to the tube to define the driveshaft. The method may also include the step of stir welding a balance weight to said tube after stir welding said yoke to said tube.

In an alternative embodiment, the present invention includes a driveshaft formed by the process of: providing a tube having an inner surface and a wall end, wherein the inner surface defines a cavity; providing a yoke having a pilot including a contact shoulder; disposing the contact shoulder against the wall end to create a joint interface; and stir welding the yoke to the tube to create a weld.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is an exploded perspective view of a portion of a drive shaft;

FIG. 2 is a partial sectional view of a stir welded drive shaft;

FIG. 3 is a partial sectional view of a drive shaft welded with a first alternate probe;

FIG. 4 is a partial sectional view of the drive shaft welded with a second alternative probe;

FIG. 5 is a plan view of a stir welding tool including a probe;

FIG. 6 is a partial sectional view of a drive shaft having a first alternative weld location;

FIG. 7 is a sectional view of a first alternative drive shaft;

FIG. 8 is a partial sectional view of a second alternative drive shaft; and

FIG. 9 is a perspective view of a drive shaft being stir welded.

### DETAILED DESCRIPTION OF THE PREFERRED EMBODIMENT

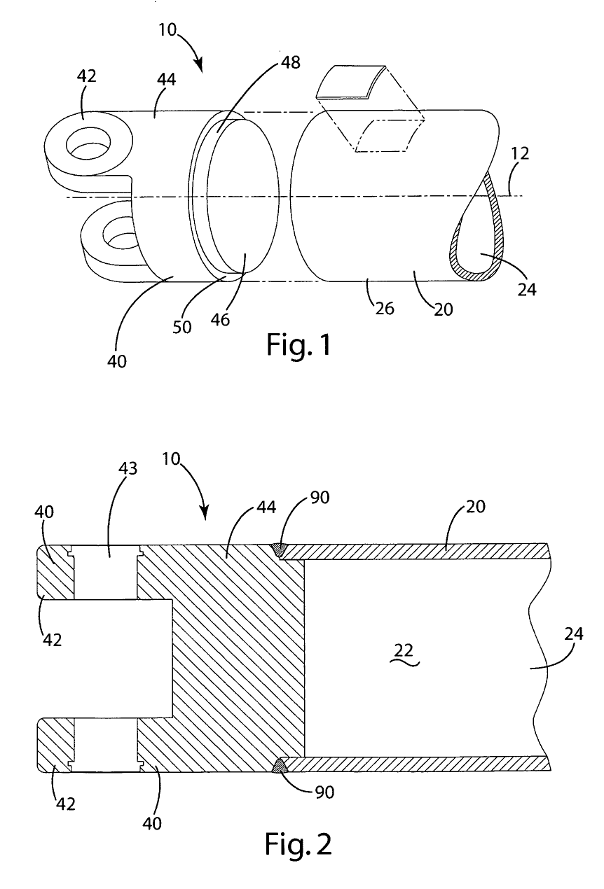

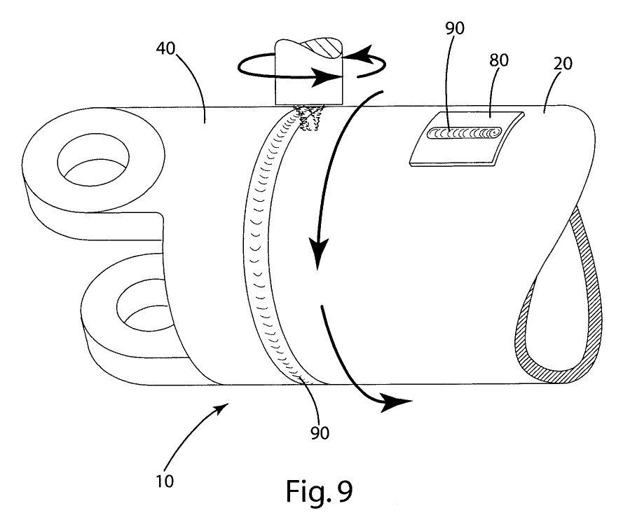

A drive shaft 10 formed by a stir welding process is illustrated in FIGS. 2 and 9. The drive shaft 10 includes a tube 20, a yoke 40, and an axis 12, as shown in FIGS. 1 and 2. The tube 20 is attached to the yoke 40 by a stir welding process.

The tube 20 is an elongated hollow shaft formed from steel, aluminum, or any other acceptable metallic material. The tube 20 includes an inner surface 24, an outer surface 26, and wall ends 28. The inner surface 24 defines a cavity 22. Hollow drive shaft tubes 20 as illustrated in FIGS. 1-6 are generally well known in the art.

The yoke 40 may be formed in a variety of sizes and shapes and configurations as needed to fit different vehicle applications. The yoke 40 generally has a body portion 44 with ears 42 extending therefrom. The ears 42 include bores 43 for receiving a U-joint (not shown) that connects the drive shaft 10 to other rotary members of the vehicle. Although only a portion of the drive shaft is illustrated in the figures, the opposing end of the tube 20 may be attached to a second yoke or other member through a stir welding process as described in greater detail below. A tube engaging pilot 46 extends from the body 44 as illustrated in FIG. 1 and includes a contact surface 48 and an outer shoulder 50. As illustrated in FIGS. 1 and 2, when the tube 20 and yoke 40 are assembled to be welded, the outer shoulder 50 of the yoke 40 engages the wall end 28 of the tube 20 to create a joint interface 36 with the tube 20. The tube 20 is further supported by contact surface 48 against pressure applied during the stir welding process. The yoke 40, as illustrated in FIGS. 1-6, is generally known in the art. Preferably the tube 20 and yoke 40 are made out of aluminum, such as 6000-series aluminum.

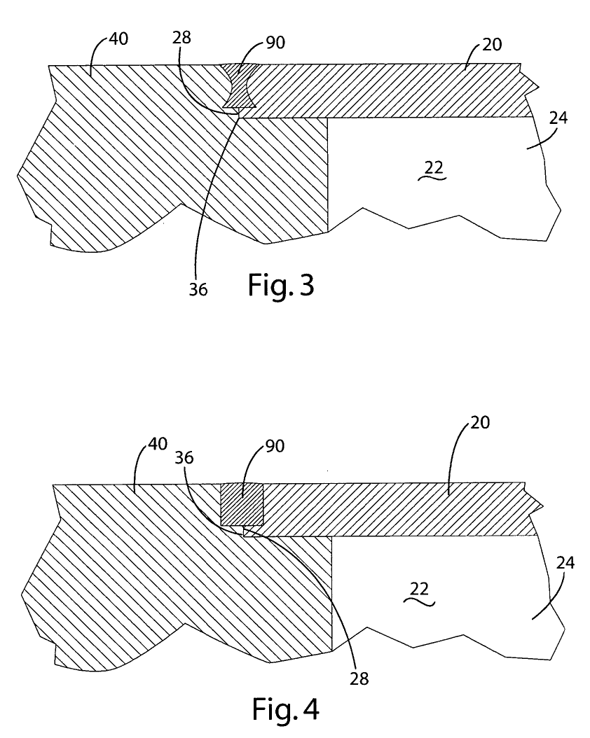

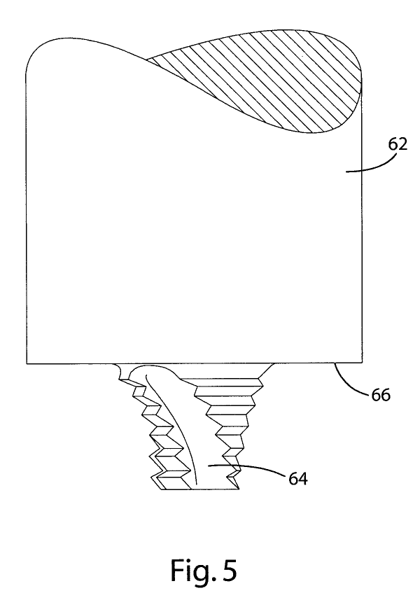

The tube 20 is stir welded to the yokes 40 with a weld 90 as shown in FIGS. 2-9. More specifically, a stir welding apparatus generally shown at 60 in FIG. 5 spins a stir welding tool 62 having a probe 64 and a tool shoulder 66 at a high speed. The probe 64 illustrated in FIG. 5 penetrates the material along the joint interface 36 until the tool shoulder 66 engages the outer surface 26 of the tube 20. The rotating stir welding tool 62, specifically the probe 64, generates friction heat between the tube 20 and yoke 40 at the joint interface 36. This frictional heat raises the temperature of the tube 20 and yoke 40 to just below the melting point of the material where deformation of material is easy; thus the tool 20 can move plasticized metal around the tool 20. By raising the temperature to just below the melting point, heat distortion away from joint interface 36 is minimized. Further, by keeping the temperature just below the melting point, heat distortion near the joint interface 36 is also minimized. The metal along the joint interface 64 is extruded around the probe 64, while the probe is rotating, and forged by the downward pressure exerted from the tool shoulder 66, closing up the joint interface 36 and creating the weld 90. The drive shaft 10, including the yoke 40 and tube 20, is rotated about the axis 12 so that the stir welding tool 62, specifically the probe 64, creates the weld 90 around the circumference of the drive shaft 10 to attach the tube 20 to the yoke 40. Of course the drive shaft 10 may remain stationary while the tool 62 rotates about the axis 12. The stir welding tool 62 is formed from a substantially harder material that has a greater melting point than the material forming the tube and yoke. In the illustrated embodiment, the stir welding tool is formed from steel, such as a tool steel. The probe 64 may vary in design, which determines the flow direction of the plasticized metal and shape of the weld 90. FIGS. 2-4 and 8 show the use different shaped probes 64 to create the different shaped welds 90. For example, the probe 64 illustrated in FIG. 5 is similar to the probe used to create the weld 90 shown in FIG. 8. Rectangular shaped probes create a weld similar to the weld 90 shown in FIG. 4, cone shaped probes create a weld similar to the weld 90 shown in FIGS. 2 and 6-7, and hourglass shaped probes form a weld similar to the weld 90 shown in FIG. 3.

If needed to correct imbalance of the drive shaft 10, the drive shaft 10 may further include a balance weight 80 located on the outer surface 26 of the tube 20, as illustrated in FIG. 9. In some embodiments, more than one balance weight 80 may be needed to properly balance the drive shaft 10. The balance weight 80 generally has a shape that allows it to be easily attached to the tube 20 such as curved surface (not shown) matching the curve of the outer surface 26 of the tube 20. As illustrated in FIG. 9, the weld 90 may be an elongated line although the inventors have found that plunging the probe 64 through the balance weight 80 and into the tube 20 in a singular spot with minimal lateral or longitudinal movements provides a sufficiently strong weld to bond the balance weight 80 to the tube 20. Both methods of attaching the balance weight 80 minimize heat distortion. The balance weight 80 may come in different sizes, shapes, masses, and configurations as needed. The selection of a particular balance weight and determining the location on the drive shaft 10 uses processes generally known in the art.

Stir welding the drive shaft 10 keeps heat to a minimum, thereby keeping the temperature below the melting point of the components of the drive shaft 10 to minimize any heat related distortion. Even though the tool 62, specifically the shoulder 66, is applied to the workpiece, i.e., the drive shaft 10, with a vary large downward force, the inventors have found that hollow tube 20 of the drive shaft 10 can withstand the forces present in stir welding without deformation from the downward pressure or rotational pressure, while having less heat deformation problems than conventional welding techniques. Another advantage of stir welding the drive shaft 10 is that the weld joint 90 has been found to have excellent mechanical properties as compared to traditional joining methods such as gas-metal-arc welding, friction welding, and laser welding. Further, with no filler material used in stir welding, as compared to many of the above discussed traditional welding techniques, distortion imbalances resulting from added welding material and splatter are eliminated and variable costs are reduced. Stir welding can also improve tolerate variations in material compositions or joint fit-up, thereby improving quality.

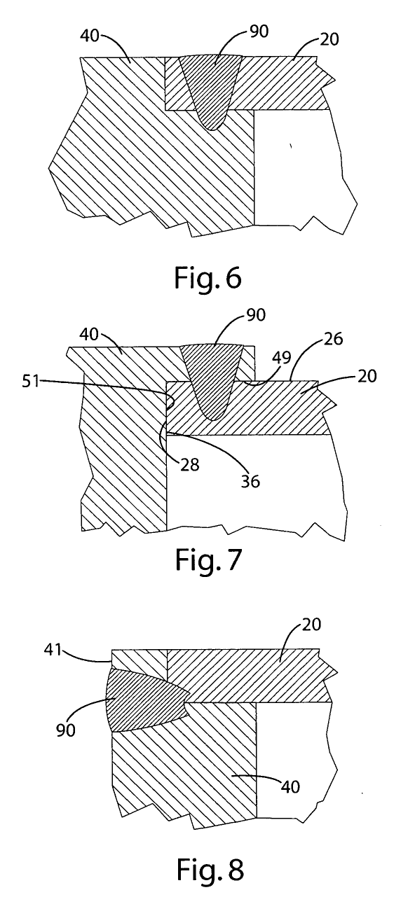

The preferred method is discussed below, but various changes in the order of steps or substitution of other steps may provide a stir welded drive shaft 10 as claimed in the claims. The yoke 40 and tube 20 are made to the desired specification, shapes, and configurations. The yoke 40 and tube 20 are then secured in a stir welding machine. The desired stir welding tool 62, including the desired probe 64 with the desired shape, is selected and secured in the stir welding machine. The stir welding tool 62 including the probe 64 is then rotated at a high speed and plunged into the joint interface 36 until the stir welding tool 62 rests against the outer surface 26 of the tube 20 and the outer surface of the yoke 40 with the tool shoulder 66. While the stir welding tool 62, including the probe 64, is spinning at a high speed, the tube 20 and yoke 40 are rotated at a desired speed about the axis 12 so that a circumferential weld 90 is formed at the joint interface 36 to form the drive shaft 10. As specified below, the location of the weld 90 may be moved to the alternative embodiments as illustrated in FIGS. 6-8. The shown embodiments are exemplary in nature and it should be readily recognized that the weld may occur wherever it can sufficiently secure the tube 20 to the yokes 40. Upon complete rotation of the drive shaft, the stir welding tool 62 including probe 64 is withdrawn from the drive shaft 10 having formed a circumferential weld at the joint interface 36. The process is then repeated to stir weld the other yoke 40 or other part to the other end of the tube 20, if necessary. Of course, it should be readily recognized that the stir welding machine may weld the second yoke 40 to the other end of the tube 20 without removal from the machine or that the stir welding machine for efficiency may stir weld both yokes 40 simultaneously to the tube 20. Further, it should be readily recognized that a sufficient weld 90 may be created at the joint interface 36 without a complete circumferential weld or with circumferential broken welds (not shown).

One advantage of the stir welding process over other welding processes is that once the stir welding of the joint interface 36 is finished, the drive shaft 10 on the same machine may be spun to determine if and where balance weights 80 need to be added. The balance weights 80 are then added by placing the balance weights 80 against the outer surface 26 of the tube 20 and then plunging the stir welding tube tool 62, specifically the probe 64, through the surface of the balance weight 80 and into the tube 20. By stir welding of the yokes 40 to the tube 20 as well as the balance weights 80 onto the tube 20 in one operation, manufacturing and assembly time may be shortened, thereby lowering the cost of the drive shaft.

As illustrated in FIGS. 2-4 and 6-8, the weld 90 may have a variety of sizes, shapes, and locations. In the alternative embodiment shown in FIG. 6, the weld 90 is offset from the outer extension 37 of the joint interface 36 to weld the inner surface 24 of the tube 20 to the contact surface 48 of the yoke 40. In FIG. 7, a first alternative drive shaft embodiment is illustrated where the tube 20 fits within the yoke 40 so that the wall end 28 and the inner shoulder 51 are engaged and the outer surface 26 engages an inner surface 49. The weld 90 may be moved as desired, including to a position located along the joint interface 36. In the second alternative drive shaft shown in FIG. 8, the weld is located on the outer end 41 of the yoke 40.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A driveshaft formed by the process of:
providing a yoke and a tube; and
stir welding said yoke to said tube to define the driveshaft.

2. The driveshaft of claim 1 further including providing a balance weight and stir welding said balance weight to said tube after stir welding said yoke to said tube.

3. The driveshaft of claim 1 wherein said yoke includes a body and a pilot, said pilot being inserted into said tube before stir welding said yoke to said tube to define the driveshaft.

4. The driveshaft of claim 3 wherein said pilot includes a contact surface and an outer shoulder, said contact surface and said outer shoulder engaging said tube to form a joint interface and wherein said yoke is stir welded to said tube along said joint interface.

5. The driveshaft of claim 3 wherein said yoke and tube are rotated as said yoke is stir welded to said tube.

6. The driveshaft of claim 1 further including the steps of providing a machine for stir welding said yoke and tube and clamping said yoke and said tube into said stir welding machine before stir welding said yoke to said tube.

7. The driveshaft of claim 6 wherein said yoke and said tube include an axis and wherein said stir welding machine rotates said yoke and said tube about said axis as said yoke is stir welded to said tube.

8. The driveshaft of claim 6 wherein after said yoke and said tube are stir welded, said stir welding machine rotates said stir welded yoke and shaft about an axis to ensure the driveshaft is balanced.

9. The driveshaft of claim 6 wherein after said yoke and said tube are stir welded, said stir welding machine rotates the driveshaft about an axis to measure imbalance of the driveshaft.

10. The driveshaft of claim 9 wherein if the stir welding machine measures an imbalance in the driveshaft, the stir welding machine determines locations for adding at least one balance weight to said tube.

11. The driveshaft of claim 10 wherein said stir welding machine stir welds said at least one balance weight to said tube.

12. A method of forming a driveshaft comprising the steps of:
coupling a yoke and a tube to a stir welding apparatus;
engaging said yoke against said tube; and
stir welding said yoke to said tube to define the driveshaft.

13. The method of claim 12 further including the step of stir welding a balance weight to said tube after stir welding said yoke to said tube.

14. The method of claim 12 wherein said step of stir welding said yoke to said tube further includes the step of rotating said yoke and said tube about an axis as said yoke is stir welded to said tube.

15. A driveshaft formed by the process of:
providing a tube having an inner surface and a wall end, said inner surface defining a cavity;
providing a yoke having a pilot including a contact shoulder;
disposing said contact shoulder against said wall end to create a joint interface;
stir welding said yoke to said tube to create a weld, said stir welded yoke and tube defining the driveshaft.

16. The driveshaft of claim 15 wherein said tube and yoke are stir welded at said joint interface.

17. The driveshaft of claim 15 wherein said pilot further includes a contact surface engaging said inner surface and wherein said joint interface includes an outer extension, said weld being offset from said outer extension and wherein said weld couples said inner surface to said contact surface.

18. The driveshaft of claim 15 wherein said pilot further includes an inner contact surface and said tube includes an outer surface engaging said inner contact surface, and wherein said joint interface includes an outer extension, said weld being offset from said outer extension and wherein said weld joins said outer surface to said inner contact surface.

19. The driveshaft of claim 15 wherein said tube further includes a contact engaging surface, and said tube includes an inner surface engaging said contact surface and wherein said weld joint is aligned with said tube and wherein said weld joins said wall end, said inner surface, said contact surface and said shoulder.

20. The driveshaft of claim 19 wherein said yoke further includes an outer yoke surface and wherein said weld is displaced from said outer yoke surface.
